(19) United States
(12) Patent Application Publication
(10) Pub. No.: US 2016/0138509 A1
(43) Pub. Date: May 19, 2016

(54) DETERMINING START OF INJECTION OF AN INJECTOR OF AN INTERNAL COMBUSTION ENGINE

(71) Applicant: MTU FRIEDRICHSHAFEN GMBH, Friedrichshafen (DE)

(72) Inventors: Michael WALDER, Ravensburg (DE); Andreas MEHR, Kressbronn (DE); Frank MLICKI, Radolfzell (DE); Markus STAUDT, Ravensburg (DE); Robby GERBETH, Friedrichshafen (DE)

(21) Appl. No.: 14/897,804

(22) PCT Filed: Jun. 3, 2014
(86) PCT No.: PCT/EP2014/001491

§ 371 Date: Dec. 11, 2015

(30) Foreign Application Priority Data
Jun. 12, 2013 (DE) 10 2013 210 984.9

(51) Int. Cl. F02D 41/26; F02D 41/14

(52) U.S. Cl. CPC F02D 41/26; F02D 41/1401; F02D 2041/1432; F02D 2041/286

(57) ABSTRACT

A method for determining a start of injection of an injector of an internal combustion engine, including the following steps: time-resolved detecting of an individual storage pressure curve in a measurement interval; determining a test injection start with the aid of the individual storage pressure curve; determining a tendency of the individual storage pressure curve in a predetermined test interval prior to the test injection start; correcting the individual storage pressure curve subject to the tendency; and determining a start of injection with the aid of the corrected individual storage pressure curve.

The invention pertains to a method for determining the start of injection of an injector of an internal combustion engine according to claim 1, to a control unit for an internal combustion engine according to the introductory clause of claim 9, and to an internal combustion engine according to the introductory clause of claim 10.

German Offenlegungsschrift DE 10 2009 056 381 A1 describes a method for the open-loop and closed-loop control of an internal combustion engine, in which, among other things, the time at which an injector starts to inject is determined by detecting the pressure in the individual accumulator of the injector, wherein, on that basis, a representative start of injection and a test injection start are determined, and wherein the representative start of injection is checked for plausibility against the test injection start. The injector, for which the start of injection is determined, is part of an injection system with a common rail, i.e., a common high-pressure accumulator device, or so-called common-rail injection system. The common high-pressure accumulator system, from which all of the injectors of the injection system are supplied, is provided with fuel by a high-pressure pump. During the operation of the internal combustion engine, a wave-shaped pressure curve develops in the high-pressure system, which propagates into the individual accumulator areas of the individual injectors. This so-called pump wave, which has the same frequency as the conveying frequency of the high-pressure pump, is superimposed on the detected individual accumulator pressure curve. In the known methods for determining the start of injection, the results differ, depending on the phase relationship of the start of injection to the pump wave. This effect impairs the accuracy of the determination of the injection start and thus the reproducibility of the individual accumulator pressure analysis.

The invention is therefore based on the goal of creating a method which does not suffer from the disadvantage just mentioned. In particular, it should be possible with the help of the method to increase the evaluation accuracy of the individual accumulator pressure analysis and thus to increase the accuracy with which the start of injection can be determined, wherein preferably the result of the evaluation, i.e., the determined start of injection, should no longer be dependent on its phase relationship to the pump wave. The invention is also based on the goal of creating a control unit for the internal combustion engine by means of which the method can be implemented. The invention is also based on the goal of creating an internal combustion engine in which it is possible to determine the start of injection according to the method proposed here.

The goal is achieved by creating a method with the steps of claim 1. These steps include the detection of a time-resolved individual accumulator pressure curve within a measurement interval. It is obvious that the detected individual accumulator pressure curve is preferably stored, wherein the subsequent evaluation steps are then preferably carried out on the basis of the stored individual accumulator pressure curve. On the basis of the individual accumulator pressure curve, a test injection start is determined. In a previously determined test interval prior to the test injection start, the trend of the individual accumulator pressure curve is determined. Here the phrase “prior to the test injection start” means that the test interval beginning with the test injection start extends in the direction toward earlier points in time—measured either in units of time or in units of the crankshaft angle of the internal combustion engine. The individual accumulator pressure curve can thus be detected in time-resolved fashion either as a function of time or as a function of the crankshaft angle of the internal combustion engine; the results can be easily converted into each other on the basis of the rotational speed of the internal combustion engine, which is preferably also detected. To this extent, the formulation “prior to the test injection start” means that the test interval extends in time toward points prior to the test injection start or in the direction toward smaller crankshaft angles. The individual accumulator pressure curve is corrected on the basis of the trend, and a start of injection is determined on the basis of the corrected individual accumulator pressure curve. In that the trend of the individual accumulator pressure curve is determined prior to the test injection start, the phase relationship of the test injection start to the pump wave is also acquired, at least indirectly. In particular, it is possible with the help of the trend to determine whether or not the pressure curve on which the pump wave is superimposed is rising or falling. By correcting the individual accumulator pressure curve on the basis of the trend, the effect of the phase relationship to the pump wave is at least weakened, preferably eliminated completely. It is therefore possible in this way to determine the start of injection very accurately and reproducibly by means of the method, independently of the phase relationship to the pump wave. As a result, the evaluation accuracy of the individual accumulator pressure analysis is significantly increased.

The measurement interval preferably corresponds to a work cycle of the internal combustion engine, which is preferably configured as a reciprocating piston engine.

A method is preferred which is characterized in that, to determine the test injection start, a first gradient curve of the individual accumulator pressure curve is calculated. For this purpose, a local minimum of the first gradient curve is determined first. Then the nearest point on the left of the local minimum at which a value of the first gradient curve corresponds to a previously determined first default value is found. The formulation “on the left of the local minimum” means that the point lies before the local minimum; that is, it is shifted in the direction toward earlier times—measured either in units of time or in units of crankshaft angle—relative to the local minimum. This step begins by considering the gradient curve over the course of time or during a period in which the crankshaft angle is increasing, so that, when the values are plotted, a point shifted in the early direction will be located to the left of a defined reference point, in this case the local minimum. The formulation “the nearest point” is to be interpreted to mean that the first point on the left of the local minimum at which the previously mentioned condition is fulfilled is determined, i.e., the condition that the first gradient curve corresponds to the first default value. The abscissa value of the point thus determined is taken as the abscissa value of the test injection start. The determination of the test injection start corresponds to a first, relatively rough determination of the approximate position of the actual start of injection.

The individual accumulator pressure curve is preferably filtered, wherein the first gradient curve is preferably calculated from the filtered individual accumulator pressure curve. To filter the individual accumulator pressure curve, it is especially preferable to use a first filter corner frequency by means of which the individual accumulator pressure curve is filtered. To determine the first filter corner frequency, a family of characteristics is preferably used, which comprises a difference value of the individual accumulator pressure as the input variable and the filter corner frequency as the output variable. A first characteristic curve for determining the first filter corner frequency is provided. The difference value of the individual accumulator pressure is determined by finding a maximum value and a minimum value for the individual accumulator pressure in the measurement interval, wherein the difference between these values is calculated. On the basis of the difference value obtained in this way, the first filter corner frequency is determined from the family of characteristics. This procedure for filtering the individual accumulator pressure curve is described in detail in German Offenlegungsschrift DE 10 2009 056 381 A1; see there in particular paragraphs [0021] and [0022]. The disclosure offered there is to this extent included in its entirety in the disclosure content of the present application, and reference is herewith made to that content.

A method is preferred which is characterized in that the trend of the individual accumulator pressure is determined by establishing a test value of the individual accumulator pressure curve at a previously determined distance to the left of the test injection start, wherein the slope of the line between the test value and the test injection start is calculated. The filtered individual accumulator pressure curve is preferably used for this. Thus the procedure for determining a test value is to begin at the abscissa value assigned to the test injection start, i.e., either a time value or a crankshaft angle value, and to proceed from there by a previously determined step width in the early direction, i.e., in the direction toward shorter times or smaller crankshaft angles—the abscissa value assigned to the test injection start therefore being reduced by a previously determined differential amount—and wherein an ordinate value is then determined, namely the ordinate value corresponding to the new abscissa value calculated as just described—or, in brief, the ordinate value of the preferably filtered individual accumulator pressure curve. This ordinate value is defined as the test value. Then a straight light is drawn through the test value and the ordinate value assigned to the test injection start, and the slope of this line is calculated. Of course, it is not absolutely necessary actually to fit a straight line to the corresponding values. To determine the slope of the line, it is preferable to divide the difference between the ordinate values of the test value and of the test injection start by the difference between the appropriately assigned abscissa values. Of course, any other suitable method for determining the slope of the line between the test value and the test injection start can also be used.

The following has been found: If the test value is greater than the ordinate value assigned to the test injection start, it can be concluded that the actual start of injection is located in a descending part of the pump wave. Conversely, it can be concluded that the actual start of injection is in an ascending part of the pump wave if the test value is smaller than the ordinate value assigned to the test injection start. A negative slope of the line thus indicates that the pump wave is descending during the time of the start of injection, whereas a positive slope indicates correspondingly that the pump wave is ascending at the start of injection. By means of the test value and the slope of the line determined from it, therefore, it is possible to infer the gradient of the pump wave at the time of injection or immediately prior to injection, namely, in the test interval. Here the test interval corresponds precisely to the previously described distance to the left, i.e., to the difference between the abscissa values of the test injection start and the test value.

As previously explained, an abscissa value always implies a point in time or a crankshaft angle assigned to the individual accumulator pressure curve or the gradient curve. The phrase “ordinate value”, conversely, implies either a pressure value assigned to the individual accumulator pressure curve or a time-derived or crankshaft angle-derived pressure value assigned to the gradient curve.

A method is preferred which is characterized in that the individual accumulator pressure curve is corrected by determining a correction function as a function of the slope of the line in the test interval, wherein the correction function is used to recalculate the preferably filtered individual accumulator pressure curve in the test interval. The correction function is preferably determined on the basis of a characteristic map, in which correction functions are stored as a function of the slopes of lines. In that the individual accumulator pressure curve in the test interval is recalculated by means of a correction function, it is corrected with respect to the course of the pump wave immediately before the start of injection or possibly even at the start of injection. In particular, the steep gradient generated by the pump wave is smoothed out, i.e., the curve of the individual accumulator pressure is flattened. In a preferred embodiment of the method, it is nevertheless possible not to compensate completely or even to overcompensate for the slope of the individual accumulator pressure curve caused by the pump wave. It has been found that, depending on the concrete slope of the individual accumulator pressure curve actually present, not completely compensating or overcompensating for the slope can increase the accuracy of the evaluation. This is taken into account accordingly in the correction functions, which are stored in the characteristic map.

In a preferred embodiment of the method, it is the unfiltered individual accumulator pressure curve which is corrected. This procedure is preferred, because the correction results in an inflection or a non-differentiable point in the corrected individual accumulator pressure curve especially at the end of the test interval located to the right, i.e., in the direction toward larger abscissa values and therefore at the end where the abscissa value for the test injection start is located. The corrected, unfiltered individual accumulator pressure curve is then preferably filtered after the correction, which has the effect of smoothing out the inflection or the non-differentiatable point. It is also possible as an alternative to correct the filtered individual accumulator pressure curve and then preferably to filter it once again.

To filter the corrected individual accumulator pressure curve, a filter corner frequency is preferably used, which is obtained from the same family of characteristics from which the first filter corner frequency was taken. Nevertheless, the difference of the individual accumulator pressure, which is used as the input variable for the family of characteristics, is determined not over the entire measurement interval but rather preferably in an evaluation window, wherein the determination of the evaluation window will be described further below The filter corner frequency is then—as will be described below—determined preferably by way of another characteristic curve of the family of characteristics, wherein the filter corner frequency used here for the filtering preferably corresponds to a second filter corner frequency, as will also be discussed further below.

In this context, a method is preferred which is characterized in that a ramp is selected as a correction function. The ramp is preferably a linear function with a previously determined slope. The slope is selected to be in particular either negative or positive, wherein typically a larger need for correction is present in the area of the left boundary of the test interval than in the area of the right boundary, where a seamless transition to the point of the test injection start is desired, so that there is no longer any correction being made here. Accordingly, the ramp descends or ascends from the abscissa value of the test value, hence from the left side of the test interval, preferably to a value on the abscissa value of the test injection start, i.e., the right boundary of the test interval, where the ordinate value of the test injection start does not change.

In a preferred embodiment of the method, the ramp is added to the preferably unfiltered individual accumulator pressure curve. In this case, it preferably falls or rises to a value of 0 at the end of the correction, namely, at the abscissa value of the test injection start, so that there is no longer any correction here.

In an alternative preferred embodiment of the method, the preferably unfiltered individual accumulator pressure curve in the test interval is multiplied by the ramp. In this, this preferably ascends to a value of 1 by the end of the correction and is therefore at the right boundary of the test interval. Multiplying by 1 results in no change in the ordinate value of the test injection start and thus in no correction.

It is especially preferable for the ramp to be read from a characteristic map, in which ramps are stored as a function of the slope of the line between the test value and the test injection start in the test interval. It is especially preferable for the slope values for the ramps to be stored as a function of the slope of the line, wherein the slope of the ramp is typically sufficient to determine the complete ramp, once its value is set at the right boundary of the test interval—at 0 or 1, depending on the calculation operation concretely selected.

Also preferred is a method which is characterized in that at least one left boundary value for an evaluation window for determining the start of injection is determined. For this purpose, proceeding from the test injection start, an abscissa value located a previously determined distance to the left of the abscissa value of the test injection start is set as the boundary value. From the abscissa value of the test injection start, therefore, a previously determined difference is subtracted, from which a new abscissa value is obtained on the left of the abscissa value of the test injection start, this new value being set as the boundary of the evaluation window. In a preferred embodiment of the method, it is possible for the left boundary value of the evaluation window to be exactly the same as the abscissa value of the test value, wherein the test interval corresponds precisely to the distance between the left boundary value and the abscissa value of the test injection start. In this case, of course, it is not necessary to determine the left boundary value in a separate step of the method. Instead, it is possible, as an alternative, to use the abscissa value assigned to the test value directly as the left boundary of the evaluation window.

A right boundary value for the evaluation window is also preferably determined. The term “right” implies that this boundary value, proceeding from the abscissa value of the test injection start, is shifted in the late direction, i.e., to longer times or larger crankshaft angles. To determine the right boundary value, a first step is preferably carried out which proceeds from the local minimum of the first gradient curve; the abscissa value of the nearest point on the right of this local minimum at which a value of the first gradient curve corresponds to the first default value is determined. In the second step, a previously determined summand is added to the corresponding abscissa value, wherein an abscissa value is thus obtained, which is used as the right boundary value. A suitable procedure for determining the right boundary value is disclosed in German Offenlegungsschrift DE 10 2009 056 381 A1, in particular in paragraph [0021]. To this extent the disclosure content of this publication is included in its entirety in the disclosure content of the present application, and reference is made thereto. It should be emphasized that the determination of the test value according to the present application is essentially the same as the determination of the first boundary of the evaluation window, i.e., the left boundary value, described in DE 10 2009 056 381 A1. To this extent it is therefore logical, in a preferred embodiment of the method, not to determine a separate left boundary value for the evaluation window but rather to use the abscissa value assigned to the test value as the left boundary value.

The determination of the evaluation window guarantees in particular that, within the scope of the further evaluation, the same injection event, i.e., the same start of injection, is taken into consideration as in the previous evaluation, wherein in particular the same local minimum of the gradient curve is considered. Without the definition of an evaluation window, it would be possible under certain conditions to end up with a different local minimum during the further steps of the method, as a result of which the method would no longer supply useful values.

The corrected individual accumulator pressure curve, which was preferably calculated on the basis of the unfiltered individual accumulator pressure curve, is preferably filtered within the evaluation window. It is possible in particular to smooth out a non-differentiatable point on the right boundary of the test interval resulting from the correction. To filter the corrected individual accumulator pressure curve, first a pressure difference is preferably determined between a maximum pressure and a minimum pressure in the evaluation window for the corrected individual accumulator pressure curve. On the basis of this pressure difference, a filter corner frequency preferably different from the first filter corner frequency is determined by way of a characteristic curve—preferably different from the first characteristic curve—taken from the family of characteristics for the filter corner frequencies. The corrected individual accumulator pressure curve is filtered by means of this filter corner frequency. The remaining steps of the method are preferably based on the individual accumulator pressure curve corrected and filtered in this way.

A method is preferred in which a second gradient curve is calculated in the evaluation window from the corrected and preferably filtered individual accumulator pressure curve. The following calculation is then based on the individual accumulator pressure curve which has been corrected by means of the correction function and preferably filtered. As previously indicated, the choice of the evaluation window ensures that the second gradient curve is calculated for the range of the corrected individual accumulator pressure curve which corresponds to the range of the original individual accumulator pressure curve for which the previous method steps were executed. A local minimum of the second gradient curve is determined. Then the nearest point on the left of the local minimum is determined at which the second gradient curve corresponds to a previously determined second default value. The abscissa value of the point determined in this way is taken as the abscissa value of the start of injection. It is seen that the determination of the start of injection is carried out in analogy to the determination of the test injection start, but now the second gradient curve is used, which was calculated from the corrected and preferably filtered individual accumulator pressure curve. Thus the deformation of the individual accumulator pressure curve caused by the pump wave no longer interferes with the calculation of the start of injection, because the individual accumulator pressure curve has been appropriately corrected. Thus the start of injection determined from the second gradient curve is much more accurate and reproducible than the test injection start or even than a start of injection calculated otherwise from the uncorrected individual accumulator pressure curve.

As the second default value, it is preferable to use a value which is the same as the first default value. The second default value and the first default value are thus preferably identical. Of course, in the case of a concrete implementation of the method, there is no need for a separate storage area for a second default value; on the contrary, the first default value can be made use of directly. To this extent the term “second default value” in this type of embodiment of the method serves merely to establish an abstract difference, not a concrete one. Alternatively, however, it is also possible to carry out a method in which the second default value is different from the first default value.

Finally, a method is preferred which is characterized in that, from the corrected individual accumulator pressure curve in the evaluation window, a representative start of injection and a test injection start are determined, wherein the representative start of injection is checked for plausibility against the test injection start. This procedure is preferably exactly the same as the method disclosed in Offenlegungsschrift DE 10 2009 056 381 A1, wherein, however, instead of the individual accumulator pressure curve, it is now the corrected individual accumulator pressure curve on which the method is based. In particular, preferably a representative start of injection is determined by first—as previously described—determining a pressure difference between a maximum pressure and a minimum pressure in the evaluation window for the corrected individual accumulator pressure curve. On the basis of this pressure difference, a second filter corner frequency is determined by way of a second characteristic curve of the family of characteristic curves for the filter corner frequencies. The corrected but unfiltered individual accumulator pressure curve is filtered by means of this second filter corner frequency.

The filtering described here corresponds to the previously described filtering of the corrected individual accumulator pressure curve. That the filtering is described here again does not mean that the corrected individual accumulator pressure curve is filtered twice. On the contrary, the corrected, unfiltered individual accumulator pressure curve is preferably filtered only once, in particular with the second filter corner frequency. To determine the representative start of injection, it is also possible to use a characteristic curve and thus also a filter corner frequency different from those used within the scope of the previously described filtering of the corrected individual accumulator pressure curve, for which, for example, a third characteristic curve, as described below, and a third filter corner frequency or some other fourth characteristic curve and some other fourth filter corner frequency can be used.

From the filtered, corrected individual accumulator pressure curve, a gradient curve is calculated again, from which in turn the representative start of injection is determined by establishing the point on the left of a local minimum at which the gradient curve corresponds to the second default value. This procedure is described in detail in German Offenlegungsschrift DE 10 2009 056 381 A1; see there in particular paragraph [0024]. To this extent, the disclosure content of that publication is included in the disclosure content of the present application, and reference is made thereto.

The test injection start is preferably determined in that, on the basis of the difference between the maximum pressure and the minimum pressure in the evaluation window, a third corner filter frequency is determined by way of a third characteristic curve of the family of characteristic curves for determining the filter corner frequencies. The corrected individual accumulator pressure curve is filtered with the third filter corner frequency. Another gradient curve of the accumulator pressure curve which has been filtered and corrected in this way is then calculated, and, in the previously described manner, the test injection start is determined as the point on the left of a local minimum at which the additional gradient curve corresponds exactly to the second default value. This procedure is described in detail in German Offenlegungsschrift DE 10 2009 056 381 A1; see there especially paragraph [0025]. To this extent, the disclosure of that document is included in its entirety in the disclosure content of the present application, and reference is made thereto.

In the next step, the representative start of injection and the test injection start are checked for plausibility against each other. This means that the two values are compared with each other by subtracting or dividing the values. If, in a preferred embodiment, the difference is smaller than a previously determined difference limit, wherein preferably the absolute value of the difference is considered, the representative start of injection is taken as the definitive start of injection. Otherwise, the representative start of injection and the test injection start are discarded. Alternatively, it is possible to use the quotient of the representative start of injection and the test injection start. In this case it is preferable to check to see whether or not the quotient lies in a predetermined interval around 1. If this is the case, the representative start of injection is set as the definitive start of injection; otherwise, the two values are discarded. What is ultimately checked is therefore whether or not sufficiently similar values for the start of injection are obtained from both types of calculations, i.e., on the basis of the two gradient curves filtered in different ways. If the values are similar, the result is plausible. Otherwise, it is highly probable that an error is present, and it is justifiable to discard the result.

The method for determining the start of injection for the injection event is applicable to any type of injection event. The phrase “injection event” is understood to mean an individual injection and also multiple injections in the form of a pre-injection, a primary injection, and/or a post-injection. By means of the method, therefore, the start of injection can be determined both for an individual injection and also for a pre-injection, a primary injection, and/or a post-injection.

The goal is also achieved in that a control unit with the features of claim 9 is created. This is characterized in that it is set up to implement a method according to one of the previously described embodiments. It is possible for the method to be implemented permanently in the wiring of the control unit, i.e., so to speak in the hardware of the control unit. Alternatively, it is possible for a computer program to be implemented in the control unit, which program comprises instructions of such a kind that a method according to one of the previously described embodiments is executed when the computer program is running on the control unit.

Finally, the goal is also achieved in that an internal combustion engine with the features of claim 10 is created. The internal combustion engine is characterized in that it comprises a control unit according to one of the previously described exemplary embodiments. The control unit is thus set up to execute a method according to one of the previously described embodiments.

The internal combustion engine also comprises an injection system, especially a common-rail injection system, with at least one injector, wherein the at least one injector comprises an individual accumulator as a supplemental buffer volume. The fuel to be injected is taken directly from the individual accumulator and not from the rail or the common line or the common high-pressure accumulator. This leads to an additional degree of decoupling of the injectors from each other, wherein a pressure drop in the area of one injector during an injection has little or no effect on the high pressure present in the area of the other injectors. In the area of the individual accumulator of the at least one injector, a pressure sensor is provided to detect the individual accumulator pressure. This is functionally connected to the control unit, so that, by means of the control unit and the pressure sensor, the individual accumulator pressure curve can be detected in time-resolved fashion, in particular as a function of time or as a function of a crankshaft angle of the internal combustion engine. Especially when the individual accumulator pressure curve is detected as a function of the crankshaft angle, it is preferable to provide in addition a rotational speed sensor or a crankshaft angle sensor on the crankshaft of the internal combustion engine, this sensor being functionally connected to the control unit in such a way that the rotational speed or crankshaft angle of the crankshaft can be acquired by the control unit.

It has been found that the advantages already described in conjunction with the method are also realized in conjunction with respect to the control unit and the internal combustion engine.

The invention is explained in greater detail below on the basis of the drawings:

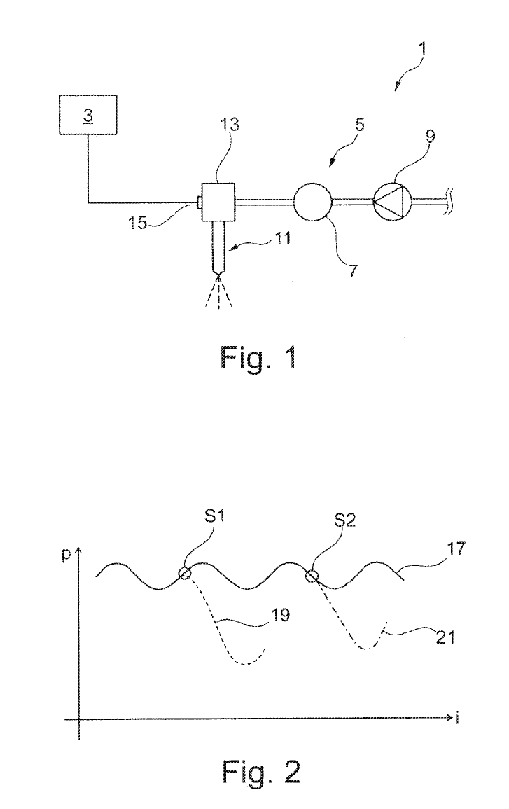

FIG. 1 shows a schematic diagram of an exemplary embodiment of an internal combustion engine;

FIG. 2 shows a graph of an individual accumulator pressure curve;

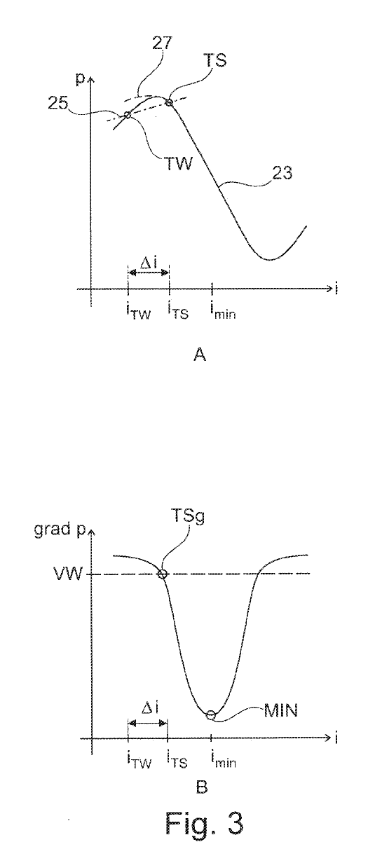

FIG. 3A shows a graph of part of an individual accumulator pressure curve in the area of an injection event;

FIG. 3B shows a graph of the gradient curve calculated from the individual accumulator pressure curve according to FIG. 3A; and

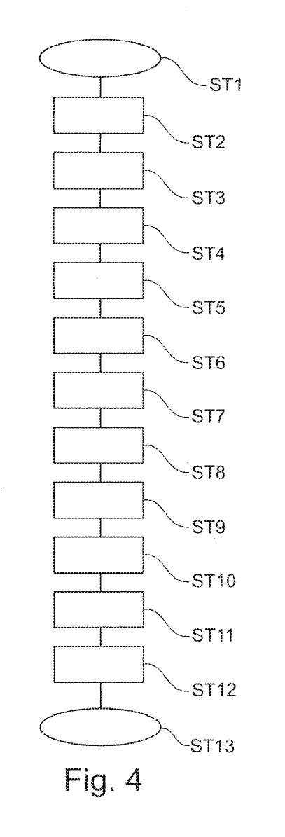

FIG. 4 shows a flow chart of one embodiment of the method.

FIG. 1 shows a schematic diagram of an exemplary embodiment of an internal combustion engine 1. The internal combustion engine 1 is preferably configured as a reciprocating piston engine. In a preferred exemplary embodiment, the internal combustion engine 1 serves to drive in particular a heavy land vehicle such as a mining vehicle and or a train, wherein the internal combustion engine 1 is used in a locomotive or railcar, or to drive ocean-going vessels or ships. The use of the internal combustion engine 1 to drive a vehicle serving defensive purposes such as a tank is also possible. According to another exemplary embodiment, the internal combustion engine 1 is stationary; for example, it can be used in a stationary energy supply installation to generate emergency power, continuous-load power, or peak-load power, wherein the internal combustion engine 1 in this case preferably drives a generator. A stationary application of the internal combustion engine 1 to drive an auxiliary unit such as a fire-extinguishing pump on an offshore drilling platform is also possible. The internal combustion engine 1 is preferably configured as a diesel engine, as a gasoline engine, as a gas engine for operation with natural gas, biogas, special gas, or some other suitable gas. Especially when the internal combustion engine 1 is configured as a gas engine, it is adapted to use in a block-type thermal power station for stationary power generation.

The internal combustion engine 1 comprises a control unit 3, which is preferably configured as an electronic control unit and which controls the internal combustion engine 1 in open-loop and/or closed-loop fashion. The internal combustion engine 1 also comprises an injection system 5 comprising a common high-pressure accumulator 7, which is supplied with fuel by a high-pressure pump 9. The common high-pressure accumulator 7 supplies all of the injectors of the internal combustion engine 1 with fuel. To this extent the injection system 5 is also configured as a so-called “common-rail” injection system.

By way of example, FIG. 1 shows an injector 11, which comprises an individual accumulator 13 as supplemental buffer volume. During an injection event, the fuel injected through the injector 11 is taken from the individual accumulator 13, not directly from the high-pressure accumulator 7. After the injection, the individual accumulator 13 is filled back up again from the high-pressure accumulator 7. This has the effect of improving the degree to which the various injectors are decoupled from each other, wherein the pressure waves caused by the individual injection events have little or no effect on the injection results of nonparticipating injectors.

To detect the individual accumulator pressure in the individual accumulator 13, an individual accumulator pressure sensor 15 is arranged on the injector 11, in particular on the individual accumulator 13; the sensor is functionally connected to the control unit 3, so that the individual accumulator pressure in the individual accumulator 13 can be detected, especially in a time-resolved manner, and stored.

It has been found that the delivery frequency of the high-pressure pump 9 acts on the pressure in the injection system 5, wherein, a pressure wave, namely, a so-called pump wave, caused by the superimposition of the delivery frequency, has an effect on the individual accumulator pressure detected in the individual accumulator 13 by the individual accumulator pressure sensor 15. This is shown schematically in FIG. 2.

FIG. 2 shows a graph of the time-resolved pressure p detected in the individual accumulator 13, plotted against a control variable i, wherein the time or a crankshaft angle of the crankshaft of the internal combustion engine 1 is preferably selected as the control variable. In an especially preferred embodiment of the method, the individual accumulator pressure curve is detected as a function of the crankshaft angle, so that in this case the control variable i represents the crankshaft angle.

On the basis of FIG. 2, it can be seen that the pressure p in the individual accumulator 13 follows the pump wave, which is shown as the solid curve 17. A first injection event is indicated by a first, dashed curve 19, wherein a first injection start S1 lies in the ascending part of the pump wave 17. A second, dash-dot curve 21 shows a second injection event, wherein a second injection start S2 lies in a descending part of the pump wave 17. The slope of the pressure p in the individual accumulator 13, which varies because of the pump wave 17, means that known methods for determining the start of an injection, especially the method known from Offenlegungsschrift DE 10 2009 056 381 A1, gives back results which vary as a function of the phase relationship of the injection event to the pump wave 17, so that the evaluation accuracy with respect to the actual start of an injection is limited. This is the starting point of the present invention; by means of the proposed method, the evaluation accuracy of an individual accumulator pressure analysis in particular can be increased.

FIG. 3A show a graph of an individual accumulator pressure curve p, plotted against the control variable i, wherein the solid curve 23 indicates an as-yet-uncorrected individual accumulator pressure curve for an injection event, in which the start of injection lies in an ascending part of the pump wave 17. It is clear that the pressure p first rises with the pump wave 17 and then, because of the beginning of the injection, it drops, passing through a minimum approximately at the time when the injection ends. It then starts to rise again, because the individual accumulator 13 is being filled up from the high-pressure accumulator 7.

The first step now is to calculate a first gradient curve of the individual accumulator pressure curve.

FIG. 3B shows a graph of the first gradient curve grad p, plotted against the control variable i. It can be seen that the first gradient curve grad p starts out with a positive value because of the ascending pump wave 17, and then drops when injection begins. In the part of the individual accumulator pressure curve which is decreasing the fastest per unit of the control variable i, the first gradient curve grad p accordingly passes through a minimum MIN, wherein it then starts to rise again at the end of injection.

Within the scope of the method, the local minimum MIN of the first gradient curve grad p is now determined first. Then, the nearest point to the local minimum MIN in the direction toward smaller values of the control variable i at which the first gradient curve grad p is equal to a previously determined first default value VW is determined. The abscissa value of this point is taken as the abscissa value i_{TS} of the test injection start TS, wherein the associated ordinate value of the first gradient curve grad p is identified in FIG. 3B by the reference symbol TSg.

As previously described, the individual accumulator pressure curve is preferably filtered prior to the calculation of the first gradient curve grad p, wherein the first gradient curve grad p is calculated from the filtered individual accumulator pressure curve.

Proceeding from the abscissa value i_{TS} of the test injection start TS located to the left of the abscissa value iₘᵢₙ—as shown in FIG. 3A—we now search for an abscissa value i_{TW} for the individual accumulator pressure curve p, namely, a value located at a previously determined distance Δi to the left; and an ordinate value, hence a value of the individual accumulator pressure curve p, is determined, which is assigned to the abscissa value I_{TW}. This ordinate value is defined as the test value TW.

Through the test value TW at one end and the test injection start TS at the other, an at least imaginary line 25, shown here as a dash-dot line, is drawn, and the corresponding slope of the line 25 between the test value TW and the test injection start TS is calculated. On the basis of this slope, in a preferred embodiment of the method, a correction function in the form of a ramp is determined from a characteristic map.

The distance Δi on the abscissa corresponds to a test interval, in which the trend of the individual accumulator pressure curve p is determined on the basis of the slope of the line between the test value TW and the test injection start TS. In this test interval Δi, the preferably unfiltered individual accumulator pressure curve p—as shown in FIG. 3A—is now corrected, in that it is recalculated by means of the ramp. In FIG. 3A, the individual accumulator pressure curve corrected in the test interval Δi is shown as the dashed curve section 27.

It can be seen here that the corrected individual accumulator pressure curve is not perfectly parallel to the abscissa in the test interval Δi. The compensation for the slope caused by the pump wave 17 is therefore not complete. Within the scope of the method, it is possible that, depending on the concrete slope of the uncorrected individual accumulator pressure curve, the slope is either not compensated completely or possibly even overcompensated. Obviously, it is also possible that, depending on the concrete slope, the compensation could be complete, wherein, in that case, the curve section 27 of the individual accumulator pressure curve would be parallel to the abscissa. This is taken appropriately into account in the characteristic map comprising the correction function, here in particular the ramp, as a function of the slope of the line, wherein the correction functions, i.e., the ramps, are selected so that an especially accurate result for the determination of the start of injection is obtained.

Within the scope of the method, an evaluation window is preferably determined for the analysis of the individual accumulator pressure curve and of the gradient curve; wherein an “evaluation window” is to be understood here as an interval of the control variable i, in which the control variable i extends over a defined range of interest of between a minimum value and a maximum value. The minimum value of the control variable i for the range of interest, hence, a left boundary value for the evaluation window, is determined by specifying, as the boundary value, an abscissa value located a previously determined distance to the left of the abscissa value i_{TS} of the test injection start TS. In a preferred embodiment of the method, it is provided that the abscissa value i_{TW} assigned to the test value TW is used as the left boundary value. To this extent, the previously determined distance then corresponds precisely to the test interval Δi. Of course, the previously determined distance used to determine the left boundary value can also be defined in a different way, wherein then an abscissa value different from the abscissa value i_{TW} would be obtained as the left boundary value. An appropriate right boundary value for the evaluation window is preferably also determined, as previously described. For this purpose, reference is made to the disclosure content of German Offenlegungsschrift DE 10 2009 056 381 A1 and to the explanations given above.

The corrected individual accumulator pressure curve is preferably filtered in the evaluation window.

From the corrected and preferably filtered individual accumulator pressure curve, a second gradient curve is now calculated in the evaluation window. This is typically similar to the first gradient curve shown in FIG. 3B, so that there is no need to describe this further. A local minimum of the second gradient curve is determined within the evaluation window.

In a preferred embodiment of the method, the nearest point on the left of the local minimum at which the second gradient curve corresponds to a previously determined second default value is determined. The procedure is similar to that used to determine the test injection start TS, which has been explained on the basis of FIG. 3B. The second default value is preferably the same as the first default value VW. Alternatively, it is also possible to select a second default value which is different from the first default value VW.

It is possible for the start of injection determined in this way on the basis of the corrected individual accumulator pressure curve to be defined as the definitive start of injection.

Alternatively, it is possible to determine a representative start of injection and a test injection start from the corrected individual accumulator pressure curve in the evaluation window, wherein the representative start of injection is checked for plausibility against the test injection start. The procedure here is the same as that described in detail in German Offenlegungsschrift DE 10 2009 056 381 A1, so that reference can be made not only to the explanations given above but also to the disclosure content of that publication, which to this extent is included in its entirety in the disclosure content of the present application. In contrast to the procedure according to German Offenlegungsschrift DE 10 2009 056 381 A1, however, the method is now based on the individual accumulator pressure curve which has been corrected according to the method proposed here.

FIG. 4 shows a schematic diagram of a preferred embodiment of the method in the form of a flow chart. The method starts with step ST1. In the following step ST2, an individual accumulator pressure curve is detected in time-resolved fashion in a measurement interval.

In the next step ST3, a gradient curve of the individual accumulator pressure curve detected in Step ST2 is calculated.

In the next step ST4, a local minimum of the gradient curve is determined, and a test injection start located on the left of the local minimum is searched for, namely, a point at which the gradient curve corresponds to a previously determined first default value.

In the next step ST5, a test value of the individual accumulator pressure curve at a previously determined distance to the left of the abscissa value of the test injection start is determined, wherein, in the following step ST6, the slope of the line between the test value and the ordinate value of the individual accumulator pressure curve assigned to the test injection start, i.e., to the abscissa value of the injection, is calculated.

In the next step ST7, on the basis of the slope of the line, a correction function, in particular a ramp, is determined from an characteristic map; in step ST8, this correction function is used to correct the individual accumulator pressure curve in the test interval between the abscissa value of the test value and the abscissa value of the test injection start, in that it is preferably multiplied by the ramp or in that the ramp is added to the individual accumulator pressure curve.

In step ST9, at least one left boundary value for an evaluation window for determining the start of injection is determined. In step ST9, furthermore, a right boundary value for the evaluation window is preferably also defined. It has been found that step ST9 does not have to be carried out at the position shown in FIG. 4. Instead, it is also possible to define, in a corresponding manner, an evaluation window, i.e., the boundary values for this window, at some other point of the method, in particular at an earlier point. The corrected individual accumulator pressure curve is preferably filtered in the evaluation window.

In step ST10, a gradient curve is calculated from the corrected and preferably filtered individual accumulator pressure curve, wherein, in the following step ST11, a local minimum of this gradient curve is determined.

In the following step ST12, finally, the start of injection is determined as the nearest point to the left of the local minimum at which the gradient curve calculated from the corrected individual accumulator pressure curve corresponds to a previously determined, second default value, which is preferably identical to the first default value used to determine the test injection start.

The method ends with step ST13.

Overall, it can be seen that, with the help of the method, it is possible to correct in particular the slope of an individual accumulator pressure signal as a function of the gradient of a pump wave in the area of the start of injection and thus significantly to increase the evaluation accuracy of an individual accumulator pressure analysis. The concrete phase relationship of the start of injection to the pump wave then no longer has any effect on the start of injection recognized by the individual accumulator pressure algorithm.

1-10. (canceled)

11. A method for determining a start of injection of an injector of an internal combustion engine, comprising the steps of:
detecting a time-resolved individual accumulator pressure curve in a measurement interval;
determining a test injection start based on the individual accumulator pressure curve;
determining a trend of the individual accumulator pressure curve in a previously determined test interval before the test injection start;
correcting the individual accumulator pressure curve as a function of the trend; and
determining a start of injection based on the corrected individual accumulator pressure curve.

12. The method according to claim 11, wherein the step of determining the test injection start includes: calculating a first gradient curve of the individual accumulator pressure curve;
determining a local minimum of the first gradient curve; taking a nearest point left of the local minimum at which a value of the first gradient curve corresponds to a previously determined first default value as an abscissa value of the test injection start; filtering the individual accumulator pressure curve; and calculating the first gradient curve from the filtered individual accumulator pressure curve.

13. The method according to claim 12, wherein the trend of the individual accumulator pressure curve is determined by establishing a test value of the filtered individual accumulator pressure curve at a previously determined distance to the left of the test injection start, wherein a slope of a line between the test value and the test injection start is calculated.

14. The method according to claim 11, wherein an unfiltered individual accumulator pressure curve is corrected by determining a correction function as a function of a slope of the line and then using the correction function to recalculate the unfiltered individual accumulator pressure curve in the test interval, wherein the corrected individual accumulator pressure curve is filtered.

15. The method according to claim 14, wherein, as a correction function, a ramp is selected, which is added to the unfiltered individual accumulator pressure curve or is multiplied by the unfiltered individual accumulator pressure curve in the test interval.

16. The method according to claim 12, wherein at least one left boundary value for an evaluation window for determining the start of injection is determined by establishing, based on the test injection start, an abscissa value located a previously determined distance to the left of the abscissa value of the test injection start as the boundary value.

17. The method according to claim 16, wherein, in the evaluation window, a second gradient curve is calculated from the corrected individual accumulator pressure curve; wherein a local minimum of the second gradient curve is determined; wherein a nearest point on the left of the local minimum at which a value of the second gradient curve corresponds to a previously determined second default value is taken as the abscissa value of the start of injection; and wherein the second default value is equal to the first default value.

18. The method according to claim 16, wherein, from the corrected individual accumulator pressure curve in the evaluation window, a representative start of injection and a test injection start are determined, wherein the representative start of injection is checked for plausibility against the test injection start.

19. A control unit for an internal combustion engine, wherein the control unit is set up to implement the method according to claim 11.

20. An internal combustion engine, comprising a control unit according to claim 19.
